(19) United States
(12) Patent Application Publication
(10) Pub. No.: US 2019/0272535 A1
(43) Pub. Date: Sep. 5, 2019

(54) SYSTEM FOR PROVIDING OVERSEAS REMITTANCE SERVICE

(71) Applicant: SODACREW INC., Seoul (KR)

(72) Inventors: Jae Hoon KIM, Seoul (KR); Woo Jae KIM, Seongnam-si (KR)

(73) Assignee: SODACREW INC., Seoul (KR)

(21) Appl. No.: 16/418,911

(22) Filed: May 21, 2019

Related U.S. Application Data
(63) Continuation of application No. PCT/KR2016/013453, filed on Nov. 22, 2016.

(30) Foreign Application Priority Data
Nov. 22, 2016 (KR) 10-2016-0155564

(51) Int. Cl. G06Q 20/38; G06Q 20/10; G06Q 20/42

(52) U.S. Cl. CPC G06Q 20/381; G06Q 20/42; G06Q 20/102

(57) ABSTRACT

Disclosed is a system for providing an overseas remittance service, comprising: a first country remitter client for transmitting a remittance request to a service provider server; a first country local partner server for collecting the remittance from an account of a remitter; the service provider server for receiving the remittance request transmitted from the remitter client, and calculating, in consideration of the exchange rate and the remittance fee, a first amount of money to be received by a second country remittee; and a second country local partner server for remitting the first amount of money to an account of the remittee.

### CROSS-REFERENCE TO RELATED APPLICATIONS

The present application is a continuation of International Patent Application No. PCT/KR2016/013453, filed Nov. 22, 2016 which is based upon and claims the benefit of priority to Korean Patent Application No. 10-2016-0155564 filed on Nov. 22, 2016. The disclosures of the above-listed applications are hereby incorporated by reference herein in their entirety.

### BACKGROUND

Embodiments of the inventive concept described herein relate to a system for providing an overseas remittance service using FinTech.

FinTech refers to the change of financial services and industry through the convergence of finance and IT, as the combination of finance and technology. The change of financial services includes technology-based financial services that provide financial services differentiated from existing financial services by using new IT technologies such as mobile, SNS, Big Data, and the like. The change of industry is exemplified as innovative non-financial companies directly provide a user with financial services such as a payment, using their own technology. The convergence trend of IT and finance has spread worldwide. Accordingly, commercial transactions between countries and financial transactions via online and mobile have also increased.

### SUMMARY

Embodiments of the inventive concept provide a system for providing an overseas remittance service, using FinTech.

The technical problems to be solved by the present inventive concept are not limited to the aforementioned problems, and any other technical problems not mentioned herein will be clearly understood from the following description by those skilled in the art to which the inventive concept pertains.

According to an exemplary embodiment, a system for providing an overseas remittance service between a first country and a second country includes a remitter client in the first country configured to transmit a remittance request including information about a remittance amount and a remittee in the second country, to a service provider server, a local partner server in the first country configured to collect an amount corresponding to the remittance amount from an account of a remitter and to transmit approval information about the remittance request to the service provider server when the collection is completed, the service provider server configured to receive the remittance request transmitted by the remitter client, to calculate a first amount of money to be received by the remittee in consideration of an exchange rate and a remittance fee, and to transmit the remittance request to a local partner server in the second country when receiving the approval information from the local partner server in a remittance country, and the local partner server in the second country configured to remit the first amount of money to an account of the remittee, when receiving the remittance request from the service provider server.

According to an exemplary embodiment, a system for providing an overseas remittance service between a first country and a second country includes a remitter client in the first country configured to transmit a remittance request including information about a remittance amount and a remittee in the second country, to a service provider server, a local partner server in the first country configured to collect an amount corresponding to the remittance amount from an account of a remitter and to transmit approval information about the remittance request to the service provider server when the collection is completed, the service provider server configured to receive the remittance request transmitted by the remitter client, to calculate a first amount of money to be received by the remittee in consideration of an exchange rate and a remittance fee, and to transmit the remittance request to a local partner server in the second country when receiving the approval information from the local partner server in a remittance country, and the local partner server in the second country configured to remit the first amount of money to an account of the remittee, when receiving the remittance request from the service provider server.

Moreover, the service provider server may be configured to calculate a second amount of money capable of being received by the remittee when exchanging and remitting the remittance amount via a specific bank and to transmit information about the calculated first amount of money and information about a difference amount between the first amount of money and the second amount of money, to the remitter client.

Furthermore, the remitter client may be configured to receive information about a specific product from the remitter, to display the received first amount of money on a screen, to calculate the number of specific products capable of being purchased with the difference amount, based on the difference amount and a unit price of the specific product, and to display the calculated number on the screen.

Also, the service provider server may be configured to transmit information about exchange rate fluctuations between the first country and the second country, information about one or more time points at each of which the remittance request is received from the remitter, and information about an average exchange rate at the one or more time points, to the remitter client, and the remitter client is configured to display the information about the exchange rate fluctuations and the information about the one or more time points, on a screen as a graph.

In addition, the service provider server may be configured to provide the remitter client with a notification, when a current exchange rate falls to the average exchange rate or less.

Moreover, the service provider server may be configured to allow the local partner server in the first country to collect a predetermined amount from an account of the remitter at a request of the remitter, and the service provider server may be configured to save the amount collected at the request of the remitter, as a deposit to the remitter and to deduct all or part of the remittance amount from the deposit.

Furthermore, the service provider server may be configured to exchange the saved deposit into a currency of the second country when an exchange rate to the second country falls to a predetermined basic exchange rate or less and to save the exchanged deposit.

Also, the service provider server may be configured to deduct the remittance amount from the deposit to perform remittance to the second country, when an exchange rate to the second country falls to a predetermined basic exchange rate or less.

In addition, the service provider server may be configured to exchange a deposit of the first user and a deposit of the second user, based on an exchange rate between the first country and the second country, when receiving a money exchange request from a first user in the first country and a second user in the second country.

Moreover, the local partner server in the first country and the local partner server in the second country may exchange information for settlement, during the predetermined period for each predetermined period based on an amount remitted via the service provider server.

Other specific details of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is diagram illustrating a system for providing an overseas remittance service, according to an embodiment;

FIG. 2 is a view illustrating a system for providing an overseas remittance service, according to the embodiment illustrated in FIG. 1;

FIG. 3 is a view illustrating a screen of an overseas remittance service, according to an embodiment;

FIG. 4 is a view illustrating a method for providing exchange rate information, according to an embodiment;

FIG. 5 is a view illustrating a method for managing a deposit, according to an embodiment;

FIG. 6 is diagram illustrating a system that provides an overseas remittance service, according to another embodiment; and

FIG. 7 is diagram illustrating a system for providing an overseas bill issuance service, according to an embodiment.

### DETAILED DESCRIPTION

Advantage points and features of the inventive concept and a method of accomplishing thereof will become apparent from the following description with reference to the following figures, wherein embodiments will be described in detail with reference to the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the concept of the inventive concept to those skilled in the art. The inventive concept may be defined by scope of the claims. Meanwhile, the terminology used herein to describe embodiments of the inventive concept is not intended to limit the scope of the inventive concept.

The terminology used herein is for the purpose of describing embodiments and is not intended to limit the inventive concept. As used herein, the singular terms are intended to include the plural forms as well, unless the context clearly indicates otherwise. The terms “comprises” and/or “comprising” used herein does not exclude presence or addition of one or more other elements, in addition to the aforementioned elements. The same reference numerals denote the same elements throughout the specification. As used herein, the term “and/or” includes any and all combinations of one or more of the associated components.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, embodiments of the inventive concept will be described in detail with reference to accompanying drawings.

In disclosed embodiments, it is assumed that a remitter in Republic of Korea remits to United States of America or a remitter in United States of America remits to Republic of Korea. However, a country that is a target or subject of remittance is not limited thereto.

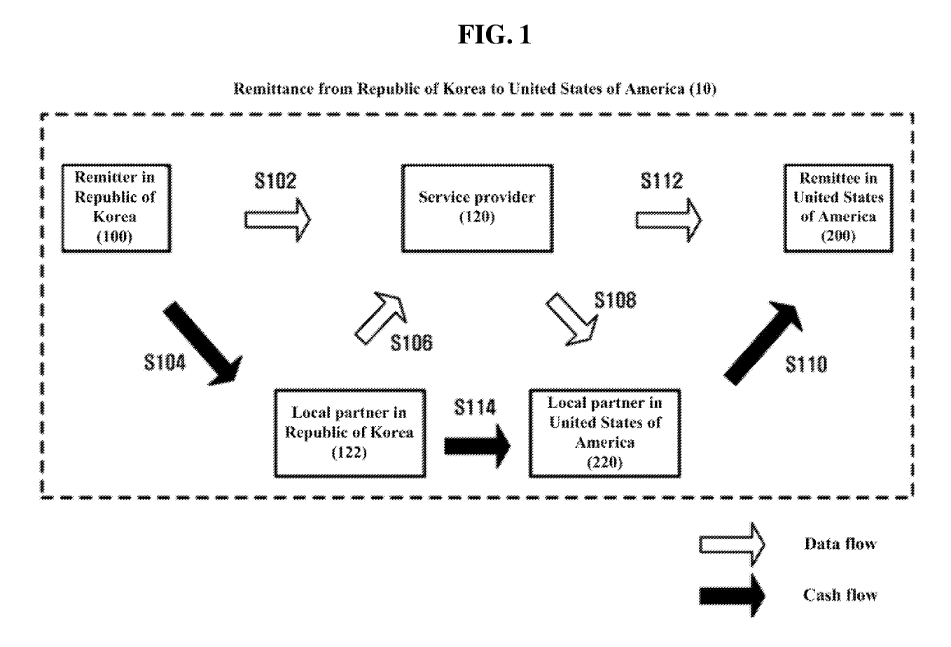

FIG. 1 is diagram illustrating a system for providing an overseas remittance service, according to an embodiment.

Referring to FIG. 1, a system 10 is illustrated to provide an overseas remittance service for the remittance from Republic of Korea to United States of America. Hereinafter, with regard to the system 10, it is assumed that the remitter 100 in Republic of Korea remits to United States of America.

Referring to FIG. 1, the system 10 may include a remitter 100 in Republic of Korea, a service provider 120, a local partner 122 in Republic of Korea, a remittee 200 in United States of America, and a local partner 220 in United States of America. Each of the remitter 100 in Republic of Korea, the service provider 120, the local partner 122 in Republic of Korea, the remittee 200 in United States of America, and the local partner 220 in United States of America illustrated in FIG. 1 means a computing device or a server that performs each operation illustrated in FIG. 1.

For example, the remitter 100 in Republic of Korea and the remittee 200 in United States of America mean a client or a computing terminal of the remitter 100 in Republic of Korea and the remittee 200 in United States of America, respectively. Furthermore, the service provider 120, the local partner 122 in Republic of Korea, and the local partner 220 in United States of America mean servers, respectively.

In operation S102, the remitter 100 in Republic of Korea makes a request for the remittance to the remittee 200 in United States of America, to the overseas remittance service provider 120. In an embodiment, the remittance request may be performed via Internet.

The service provider 120 may apply the real exchange rate to exchange the amount requested by the remitter 100 and then may calculate a remittance fee.

In an embodiment, the service provider 120 may provide the remitter 100 with the result that KRW requested by the remitter 100 is exchanged to USD. In another embodiment, the service provider 120 may provide the remitter 100 with the result that USD requested by the remitter 100 is exchanged to KRW.

In operation S104, the local partner 122 in Republic of Korea collects money from the remitter 100 in Republic of Korea. For example, the local partner 122 in Republic of Korea may collect money from at least one account of the remitter 100, using information about at least one account of the remitter 100.

The information about at least one account of the remitter 100 may include at least one of, but is not limited to, a transaction bank, an account number, an account password, a transaction bank ID of the remitter 100, and a password of the remitter 100.

In an embodiment, the remitter 100 may have a deposit to the service provider 120. In this case, the service provider 120 may perform overseas remittance using the deposit of the remitter 100, without collecting money via the local partner 122 in Republic of Korea.

In operation S106, the local partner 122 in Republic of Korea transmits information for approving a remittance request of the remitter 100, to the service provider 120 when the collection of money from the remitter 100 is completed.

In operation S108, the service provider 120 transmits remittance information about the remittee 200 in United States of America, to the local partner 220 in United States of America.

In operation S110, the local partner 220 in United States of America remits USD corresponding to KRW remitted by the remitter 100, to the account of the remittee 200 in United States of America.

In operation S112, the service provider 120 transmits the remittance information of the remitter 100 to the remittee 200 in United States of America.

In an embodiment, the service provider 120 transmits a remittance message suitable for the purpose of the remittance of the remittee 200, to the remittee 200.

For example, the remitter 100 may remit to celebrate the birthday of the remittee 200. In this case, the service provider 120 may transmit a birthday card image and a birthday celebration message written by the remitter 100 together with the remittance information.

In an embodiment, the service provider 120 may automatically determine the purpose of the remittance, based on the personal information of the remitter 100 or the remittee 200. For example, when the remittance date is the birthday of the remittee 200, the service provider 120 may automatically generate and transmit a birthday celebration message. Alternatively, the service provider 120 may generate a message based on information about a date on which the remittance has been made. For example, in the case of Christmas or Parents' day, the image and message corresponding to the corresponding date may be automatically generated and then may be transmitted to the remittee 200.

For another example, the remitter 100 may remit to pay a cost. In this case, the service provider 120 may transmit information about the payment target together with the remittance information.

For another example, the remitter 100 may perform periodic remittance such as a pin money or rent. In this case, the service provider 120 may automatically generate a remittance message based on remittance records of the remitter 100 and may transmit the remittance message together with the remittance information.

In operation S114, the local partner 122 in Republic of Korea will periodically settle the remitted amount with respect to the local partner 220 in United States of America.

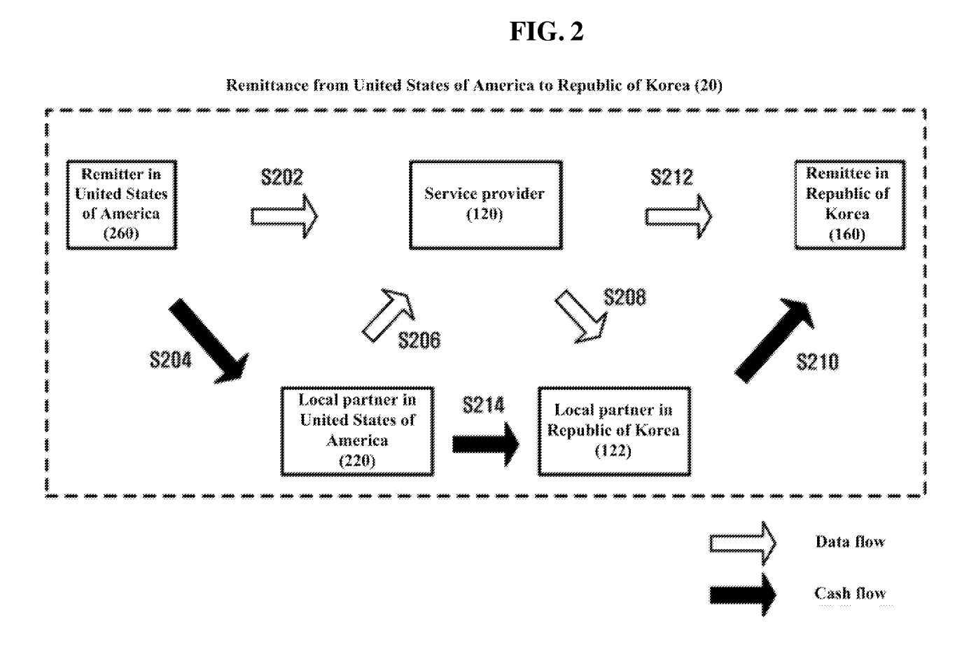

FIG. 2 is a view illustrating a system for providing an overseas remittance service, according to the embodiment illustrated in FIG. 1.

Referring to FIG. 2, a system 20 is illustrated to provide an overseas remittance service capable of remitting from United States of America to Republic of Korea. Hereinafter, with regard to the system 20, it is assumed that the remitter 260 in United States of America remits to Republic of Korea.

Referring to FIG. 2, the system 20 includes a remitter 260 in United States of America, the service provider 120, the local partner 122 in Republic of Korea, a remittee 160 in Republic of Korea, and the local partner 220 in United States of America. Each of the remitter 260 in United States of America, the service provider 120, the local partner 122 in Republic of Korea, the remittee 160 in Republic of Korea, and the local partner 220 in United States of America illustrated in FIG. 2 means a computing device or a server that performs each operation illustrated in FIG. 2.

For example, the remitter 260 in United States of America and the remittee 160 in Republic of Korea mean a client or a computing terminal of the remitter 260 in United States of America and the remittee 160 in Republic of Korea, respectively. Furthermore, the service provider 120, the local partner 122 in Republic of Korea, and the local partner 220 in United States of America mean servers, respectively.

FIG. 2 is a view illustrating another example of the system for providing the overseas remittance service illustrated in FIG. 1. Even though omitted with reference to FIG. 2, the description given with reference to FIG. 1 may be applied to the system illustrated in FIG. 2 for providing the overseas remittance service.

In operation S202, the remitter 260 in United States of America makes a request for the remittance to the remittee 160 in Republic of Korea, to the overseas remittance service provider 120.

In operation S204, the local partner 220 in United States of America collects money from the remitter 260 in United States of America.

In operation S206, the local partner 220 in United States of America transmits information for approving a remittance request of the remitter 260, to the service provider 120 when the collection of money from the remitter 260 is completed.

In operation S208, the service provider 120 transmits remittance information about the remittee 160 in Republic of Korea, to the local partner 122 in Republic of Korea.

In operation S210, the local partner 122 in Republic of Korea remits KRW corresponding to USD remitted by the remitter 260, to the account of the remittee 160 in Republic of Korea.

In operation S212, the service provider 120 transmits the remittance information of the remitter 260 to the remittee 160 in Republic of Korea.

In operation S214, the local partner 220 in United States of America will periodically settle the remitted amount with respect to the local partner 122 in Republic of Korea.

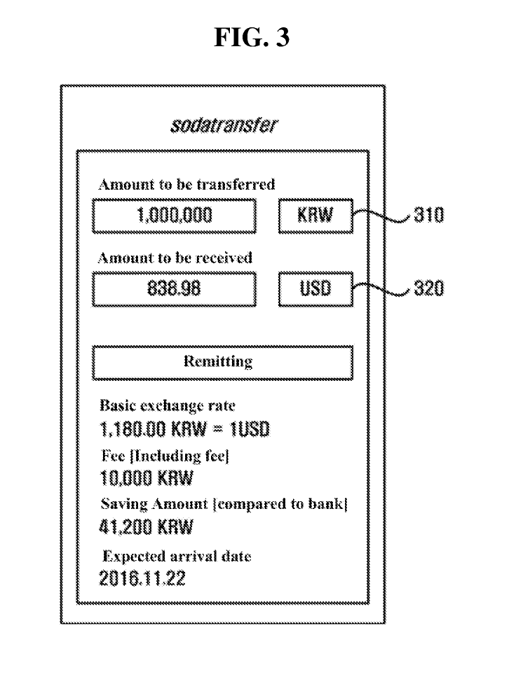

FIG. 3 is a view illustrating a screen of an overseas remittance service, according to an embodiment.

The overseas remittance service screen illustrated in FIG. 3 illustrates a screen output to the client of a remitter. In an embodiment, all or part of the information displayed on the screen may be received from the overseas remittance service provider 120 by the client of the remitter.

Referring to FIG. 3, the overseas remittance service screen displays the amount to be transferred and the amount to be received corresponding to the amount to be transferred. Furthermore, the overseas remittance service screen displays currency selecting buttons 310 and 320 capable of selecting the types of currencies of the amount to be transferred and the amount to be received corresponding to the amount to be transferred.

In an embodiment, when the amount to be remitted by a remitter is entered, the exchange rate and a remittance fee may be calculated and then the amount to be received by the remittee may be displayed. Moreover, the amount to be received is entered, the exchange rate and the remittance fee may be calculated and then the amount to be transferred by the remitter may be displayed.

In an embodiment, the amount and the type of currency may be basically set using the information about remittance records of the remitter and the remittee. The remitter may perform remittance using the amount and type of currency set by default or may perform remittance by directly entering the amount and type of currency.

In an embodiment, the overseas remittance service screen displays the amount saved as compared to remittance via a bank. Because local partners in Republic of Korea and United States of America perform periodic settlement in the overseas remittance service method according to the disclosed embodiment, the fee for exchange and the remittance fee may be saved depending on economies of scale.

Referring to the exemplification illustrated in FIG. 3, when 1,000,000 KRW is exchanged and then is remitted to United States of America, the fact that about 41,200 KRW is saved is displayed.

In an embodiment, the overseas remittance service screen is visually displayed by replacing the saving amount with another product. The overseas remittance service screen may display a product that the user is capable of purchasing at the saved 41,200 KRW, using the overseas remittance service according to the disclosed embodiment.

For example, the overseas remittance service screen may display how many cups of coffee, hamburgers, and cups of beer are capable of being purchased with the saved price of 41,200 KRW. The type of product displayed on the overseas remittance service screen may be set by a user. The user may allow the image of the desired product to be displayed on the overseas remittance service screen.

For another example, the user may set an expensive product compared with the savings. In this case, the goal may be set as saving the overseas remittance fee and then collecting the amount of money to purchase the desired product. Accordingly, the overseas remittance service screen displays what percentage of the product price desired by the user is the sum of the saving fee.

In an embodiment, the overseas remittance service screen may display the expected arrival date calculated based on the time at which the remitter makes a request for the remittance and the information about the country in which the remittee receives the remittance.

In an embodiment, the remitter client may transmit an invitation message for the overseas remittance service, based on a telephone directory, contacts, or a list of other friends.

For example, the remitter client displays the list of one or more friends on a screen and may transmit an invitation message to the friend selected by the remitter.

In an embodiment, when the remittee does not use the overseas remittance service according to the disclosed embodiment, the remitter client may transmit an invitation message to the remittee and then may perform remittance after the remittee subscribes to the service. For another example, even though the remittee does not subscribe the overseas remittance service according to the disclosed embodiment, it is possible to remit to the account of the remittee.

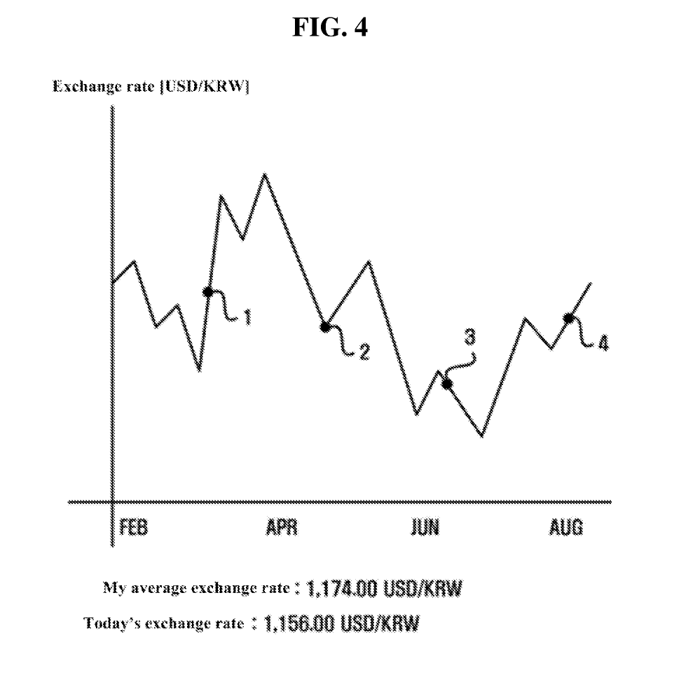

FIG. 4 is a view illustrating a method for providing exchange rate information, according to an embodiment.

Referring to FIG. 4, a graph indicating the exchange rate of USD to KRW is illustrated as an example.

In an embodiment, the service provider 120 provides the remitter client with information about exchange rate fluctuations and information about one or more remittance time points at each of which the remitter performs remittance. The remitter client may display the graph of the exchange rate fluctuations based on the received information and may display a remittance time point on a graph.

For example, four remittance time points 1 to 4 are displayed as dots in the graph illustrated in FIG. 4.

Furthermore, the service provider 120 or the remitter client may calculate an average exchange rate at one or more remittance time points. The remitter client may display an average exchange rate and a real exchange rate.

In an embodiment, when the real exchange rate reaches a predetermined point, the service provider 120 provides a notification to the remitter client. For example, when the real exchange rate falls to the average exchange rate or less of the remitter, the service provider 120 may provide provides a notification to the remitter client. The service provider 120 may provide a notification, using push notifications, text messages, e-mails, or the like. However, the method of providing the notification is not limited thereto.

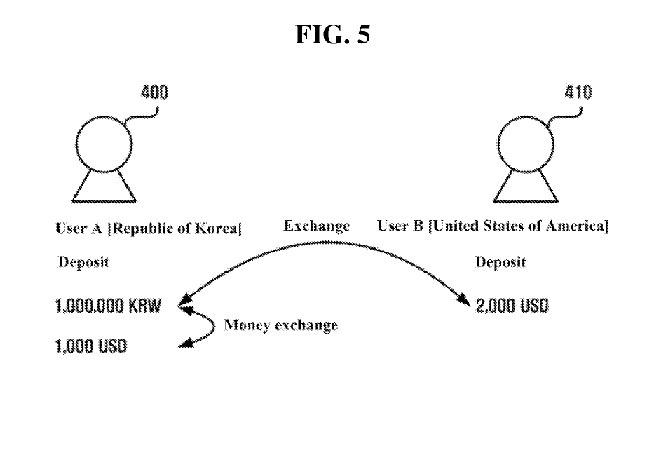

FIG. 5 is a view illustrating a method for managing a deposit, according to an embodiment.

In an embodiment, the service provider 120 may manage deposits of users.

For example, the service provider 120 allows the local partner server in a user's country to collect the predetermined amount from the user's account at the request of a user. The service provider 120 may store the collected amount as a deposit at the request of the user; when the user requests remittance afterward, the service provider 120 may deduct all or part of the remittance amount from the deposit and then may remit the deducted remittance amount.

In an embodiment, each user may exchange the deposit and then may save the exchanged deposit. For example, a user in a first country who frequently makes a remittance request to a second country may exchange all or part of the deposit into the currency of the second country and then may save the exchanged deposit.

In an embodiment, the service provider 120 observes the exchange rate between the first country and the second country. When the monetary value of the second country falls to a predetermined reference value or less, the service provider 120 may exchange the deposit of the user, which is saved as the currency of the first country, to the currency of the second country and then may save the exchanged deposit.

Also, when the monetary value of the second country falls to a predetermined reference value or less, the service provider 120 may automatically perform the remittance to the second country. For example, the user in the first country may save the deposit to remit a specific amount; when the monetary value of the second country falls to a predetermined reference value or less within a predetermined period, the user in the first country may perform the remittance.

In an embodiment, the deposit may be exchanged between a user in the first country and a user in the second country. For example, when the service provider 120 receives an exchange request from the user in the first country and the user in the second country, the service provider 120 may exchange the deposit of the first user and the deposit of the second user, based on the exchange rate between the first country and the second country. The service provider 120 may deduct a predetermined amount as a remittance fee even during the deposit exchange.

In an embodiment, the deposit exchanged between the first country and the second country may be used only to remit to the corresponding country. For example, when the user in the first country exchanges a deposit into the currency of a second country and then saves the exchanged deposit, or when the user in the first country tries to withdraw the exchanged deposit, the user in the first country needs to pay a remittance fee for the first country.

On the other hand, when the user in the first country performs the remittance to the second country by using a deposit exchanged into the currency of the second country, the user in the first country may perform the remittance to the second country without a separate remittance charge.

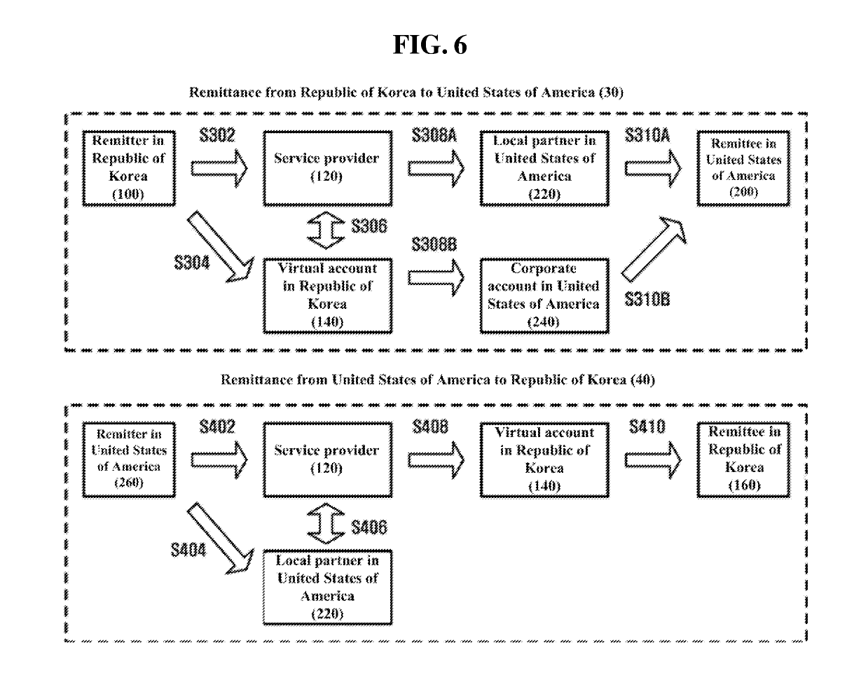

FIG. 6 is diagram illustrating a system that provides an overseas remittance service, according to another embodiment.

Referring to FIG. 6, a system 30 is illustrated to remit from Republic of Korea to United States of America. Hereinafter, with regard to the system 40, it is assumed that the remitter 100 in Republic of Korea remits to United States of America.

In operation S302, the remitter 100 in Republic of Korea may make a request for the remittance to the remittee 200 in United States of America, to the overseas remittance service provider 120. In an embodiment, the remittance request may be performed over Internet.

The service provider 120 may apply the real exchange rate to exchange the amount requested by the remitter 100 and then may calculate a remittance fee. For example, the remitter 100 may make a request for the remittance of 1,000 USD to United States of America. In this case, the service provider 120 may request the remitter 100 to exchange the requested amount into KRW using the real exchange rate and to deposit the requested amount plus a remittance fee. For example, assuming that the exchange rate is 1,000 KRW/USD and the remittance fee is 0.5%, the service provider 120 may request the remitter 100 to deposit the amount of 1,050,000 KRW. In an embodiment, the calculation of the remittance fee and the money exchange may be performed using, but is not limited, Java.

In an embodiment, the service provider 120 may issue a unique number for each remittance request. Moreover, the service provider 120 may allow the remitter 100 to enter the name or the unique number of the remitter as the name of the depositor.

In an embodiment, the service provider 120 may generate a virtual account 140 in Republic of Korea. In another embodiment, the service provider 120 may use the virtual account 140 in Republic of Korea, via company ‘PG’. In operation S304, the remitter 100 may deposit the amount requested by the service provider 120, in the virtual account 140.

In operation S306, the service provider 120 may identify the deposit to the virtual account 140 and then may determine whether the remittance request data of the remitter 100 is matched with the deposit data of the virtual account 140.

The service provider 120 may perform matching by receiving deposit records from the system of the virtual account 140. The service provider 120 may determine whether the deposit data of the virtual account is matched with the remittance request data, using at least one of the remitter's name and the remittance amount of the received deposit records.

In an embodiment, the service provider 120 may generate a unique number, using a country code of a country in which the remitter 100 performs remittance, a country code of a country in which the remittee 200 receives the remittance, and a time when the remittance is requested. For example, when the time when the service provider 120 receives a remittance request from Republic of Korea (country code 82) to United States of America (country code 01) is Jun. 28, 2016 at 6:16:32 pm (18:00), the unique number may be ‘8201160628181632’.

In an embodiment, when using the virtual account 140 via company ‘PG’, the service provider 120 may periodically check whether there is a notification of deposit records from the system of the virtual account 140, using a program that is always running. In another embodiment, when deposit records are received from the virtual account 140, the service provider 120 may call a matching algorithm.

When using the virtual account 140 generated by the service provider 120, a service user may directly identify the deposit records and may allow deposit records to be transmitted from the virtual account 140 to the system of the service provider 120.

In operation S308A, the service provider 120 may transfer data associated with the remittance request, to the local partner 220 in United States of America. The service provider 120 may operate in conjunction with the system of the local partner 220 in United States of America. The data associated with the remittance request may be transferred in, but is not limited to, XML format using API.

In operation S308B, the deposit records and remittance request may be transmitted from the system of the virtual account 140 in Republic of Korea to the system of the corporate account 240 in United States of America. The deposit records and the remittance request may be notified automatically or may be notified manually by the administrator.

In operation S310A, the withdrawal may be automatically made from the system of the local partner 220 in United States of America to the remittee 200 in United States of America. The local partner 220 in United States of America may receive data associated with the remittance request from the service provider 120 and may allow the amount corresponding to the received data to be automatically withdrawn to the account of the remittee 200 in United States of America.

In operation S310B, the local remittance may be performed from the corporate account 240 in United States of America to the remittee 200 in United States of America. The system or the administrator of the corporate account 240 in United States of America may analyze the deposit records and the remittance request received from the system of the virtual account 140 in Republic of Korea. The system or the administrator of the corporate account 240 in United States of America may perform account transfer to the account of the remittee 200 in United States of America, based on the received deposit records and remittance request.

The automatic withdrawal in operation S310A and the account transfer in operation S310B may be performed selectively or may be performed together. However, to prevent redundant remittance, the local partner 220 in United States of America performing operation S310A may operate in conjunction with the system of the corporate account 240 in United States of America performing operation S310B.

Referring to FIG. 6, a system 40 is illustrated to remit from United States of America to Republic of Korea. Hereinafter, with regard to the system 40, it is assumed that the remitter 260 in United States of America remits to Republic of Korea.

In the case of the system 40 capable of remitting from United States of America to Republic of Korea, an embodiment in which the service provider 120 of the system 30 capable of remitting from Republic of Korea to United States of America is performed is illustrated in a time-series manner Accordingly, even though omitted with regard to the system 40 capable of remitting from United States of America to Republic of Korea, descriptions about the system 30 capable of remitting from Republic of Korea to United States of America may be applied to the system 40 capable of remitting from Republic of Korea to United States of America.

In operation S402, the remitter 260 in United States of America may make a request for the remittance to the remittee 160 in Republic of Korea, to the overseas remittance service provider 120. In an embodiment, the remittance request may be performed over Internet.

The service provider 120 may apply the real exchange rate to exchange the amount requested by the remitter 260 and then may calculate a remittance fee. For example, the remitter 260 may make a request for the remittance of 1,000,000 KRW to Republic of Korea. In this case, the service provider 120 may request the remitter 260 to exchange the requested amount into USD using the real exchange rate and to deposit the requested amount plus a remittance fee. For example, assuming that the exchange rate is 1,000 KRW/USD and the remittance fee is 0.5%, the service provider 120 may request the remitter 260 to deposit the amount of 1,050 USD. In an embodiment, the calculation of the remittance fee and the money exchange may be performed using, but is not limited, Java.

In operation S404, the remitter 260 may deposit the amount requested by the service provider 120, in the account of the local partner 220 in United States of America. In operation S406, the service provider 120 may identify the deposit to the account of the local partner 220 in United States of America and then may determine whether the remittance request data of the remitter 260 is matched with the deposit data of the account of the local partner 220 in United States of America.

In operation S408, the service provider 120 may generate the virtual account 140, which is owned by the remittee 160 in Republic of Korea, in Republic of Korea and may operate in conjunction with the actual account of the remittee 160. In an embodiment, the service provider 120 may register the information about the remittee 160, which is entered by the remitter 260, and the account number of the remittee 160 in the virtual account system of company ‘PG’.

In operation S410, the service provider 120 may remit the amount requested by the remitter 260, to the actual account of the remittee 160 through the virtual account 140. In an embodiment, the service provider 120 may remit to the remittee 160 registered in the virtual account of company ‘PG’. The remitted amount may be deposited into the actual account of the remittee 160 through the virtual account of company ‘PG’.

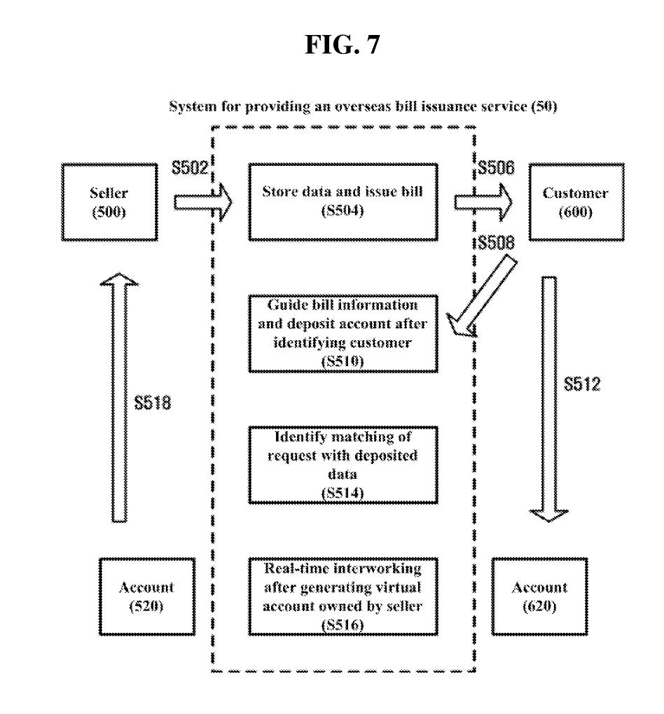

FIG. 7 is diagram illustrating a system for providing an overseas bill issuance service, according to an embodiment.

A system 50 for providing an overseas bill issuance service may be performed by the service provider 120 illustrated in FIG. 6. Accordingly, even though omitted in FIG. 7, the details given with respect to the service provider 120 of FIG. 6 may be applied to the system 50 of FIG. 7. In an embodiment, a seller 500 may be an overseas seller, and a customer 600 may be a domestic customer.

In operation S502, the seller 500 may request the system 50 to issue a bill. In an embodiment, the seller 500 may request the system 50 to issue a bill over Internet.

In operation S504, the system 50 may store data associated with a bill issuance request and may issue a bill.

In operation S506, the system 50 may transfer the bill to the customer 600. In an embodiment, the system 50 may transfer an email including a URL capable of accessing the bill, to the customer 600. A method used to transfer the bill to the customer 600 and a type of bill is not limited thereto.

In operation S508, the customer 600 may enter information of the customer 600 into the system 50. The information of the customer 600 may include, but is not limited to, names, account numbers, contacts, and the like.

In operation S510, the system 50 may identify a customer, using the information of the customer 600 received in operation S508 and may notify the customer 600 of bill information and a deposit account 620. The deposit account 620 transmitted to the customer 600 may be the actual account owned by the operator of the system 50 or may be a virtual account generated for the customer 600.

In an embodiment, when the seller 500 is an overseas seller, the system 50 may exchange the amount requested by the seller 500 by applying a real exchange rate. The system 50 may request the customer 600 to deposit the exchanged amount.

In operation S512, the customer 600 may deposit the requested amount in the deposit account 620.

In operation S514, the system 50 may match the bill of the seller 500 with the deposited amount. When the matching is successful, the system 50 may determine that the customer 600 pays the requested amount.

In operation S516, after generating a virtual account 520 owned by the seller 500, the system 50 may link the virtual account 520 to the actual account of the seller 500. The system 50 may transfer the amount deposited by the customer 600 to the seller 500 via the virtual account 520. In this case, the system 50 may transfer the amount obtained by deducting a remittance fee, to the seller 500.

When the seller 500 is an overseas seller, the system 50 may transfer the amount deposited to the seller 500, via the local partner 220 in United States of America and the corporate account 240 in United States of America illustrated in FIG. 6.

In operation S518, the seller 500 may withdraw the requested amount via the virtual account 520. When the seller 500 is an overseas seller, the seller 500 may withdraw the requested amount via the local partner 220 in United States of America and the corporate account 240 in United States of America illustrated in FIG. 6.

The steps of a method or algorithm described in connection with the embodiments of the inventive concept may be embodied directly in hardware, in a software module executed by hardware, or in a combination thereof. The software module may reside on a Random Access Memory (RAM), a Read Only Memory (ROM), an Erasable Programmable ROM (EPROM), an Electrically Erasable Programmable ROM (EEPROM), a Flash memory, a hard disk, a removable disk, a CD-ROM, or a computer readable recording medium in any form known in the art to which the inventive concept pertains.

Although embodiments of the inventive concept have been described herein with reference to accompanying drawings, it should be understood by those skilled in the art that the inventive concept may be embodied in other specific forms without departing from the spirit or essential features thereof. Therefore, it should be understood that the above embodiments are not limiting, but illustrative.

Generally, because real money exchange and inter-country remittance are required for overseas remittance, it takes a lot of time and a lot of remittance fees while the remittance passes through the banks of both countries.

According to the disclosed embodiment, a time required for remittance and a remittance fee may be reduced significantly.

Moreover, only registering account number and personal information may make overseas remittance possible without complicated procedures, and a system may perform automatic matching of each remittance request with deposit reports, thereby securing the processing speed and reliability at the same time.

Furthermore, the procedure required for bill issuance and overseas remittance may be simplified and the required time and a remittance fee may be saved, thereby activating commerce between countries.

The effects of the present inventive concept are not limited to the aforementioned effects, and other effects not mentioned herein will be clearly understood from the following description by those skilled in the art to which the inventive concept pertains.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A system for providing an overseas remittance service between a first country and a second country, the system comprising:
a remitter client in the first country configured to transmit a remittance request including information about a remittance amount and a remittee in the second country, to a service provider server;
a local partner server in the first country configured to collect an amount corresponding to the remittance amount from an account of a remitter and to transmit approval information about the remittance request to the service provider server when the collection is completed;
the service provider server configured to receive the remittance request transmitted by the remitter client, to calculate a first amount of money to be received by the remittee in consideration of an exchange rate and a remittance fee, and to transmit the remittance request to a local partner server in the second country when receiving the approval information from the local partner server in a remittance country; and
the local partner server in the second country configured to remit the first amount of money to an account of the remittee, when receiving the remittance request from the service provider server.

2. The system of claim 1, wherein the service provider server is configured to:
when exchanging and remitting the remittance amount via a specific bank, calculate a second amount of money capable of being received by the remittee; and
transmit information about the calculated first amount of money and information about a difference amount between the first amount of money and the second amount of money, to the remitter client.

3. The system of claim 2, wherein the remitter client is configured to:
receive information about a specific product from the remitter;
display the received first amount of money on a screen;
calculate the number of specific products capable of being purchased with the difference amount, based on the difference amount and a unit price of the specific product; and
display the calculated number on the screen.

4. The system of claim 1, wherein the service provider server is configured to:
transmit information about exchange rate fluctuations between the first country and the second country, information about one or more time points at each of which the remittance request is received from the remitter, and information about an average exchange rate at the one or more time points, to the remitter client, and
wherein the remitter client is configured to:
display the information about the exchange rate fluctuations and the information about the one or more time points, on a screen as a graph.

5. The system of claim 4, wherein the service provider server is configured to:
when a current exchange rate falls to the average exchange rate or less, provide the remitter client with a notification.

6. The system of claim 1, wherein the service provider server is configured to:
allow the local partner server in the first country to collect a predetermined amount from an account of the remitter at a request of the remitter, and
wherein the service provider server is configured to:
save the amount collected at the request of the remitter, as a deposit to the remitter; and
deduct all or part of the remittance amount from the deposit.

7. The system of claim 6, wherein the service provider server is configured to:
when an exchange rate to the second country falls to a predetermined basic exchange rate or less, exchange the saved deposit into a currency of the second country; and
save the exchanged deposit.

8. The system of claim 6, wherein the service provider server is configured to:
when an exchange rate to the second country falls to a predetermined basic exchange rate or less, deduct the remittance amount from the deposit to perform remittance to the second country.

9. The system of claim 6, wherein the service provider server is configured to:
when receiving a money exchange request from a first user in the first country and a second user in the second country, exchange a deposit of the first user and a deposit of the second user, based on an exchange rate between the first country and the second country.

10. The system of claim 1, wherein the local partner server in the first country and the local partner server in the second country exchange information for settlement, during the predetermined period for each predetermined period based on an amount remitted via the service provider server.
